(19) United States
(12) Patent Application Publication
(10) Pub. No.: US 2013/0227171 A1
(43) Pub. Date: Aug. 29, 2013

(54) APPARATUS AND METHOD FOR INTERCONNECTING HETEROGENEOUS NETWORKS

(71) Applicant: Electronics and Telecommunications Research Institute, (US)

(72) Inventors: Ki Hyuk NAM, Daejeon (KR); Sang Jin JEONG, Daejeon (KR); Myung Ki SHIN, Seoul (KR); Hyoung Jun KIM, Daejeon (KR)

(73) Assignee: Electronics and Telecommunications Research Institute, Daejeon (KR)

(21) Appl. No.: 13/773,048

(22) Filed: Feb. 21, 2013

(30) Foreign Application Priority Data
Feb. 24, 2012 (KR) 10-2012-0019262

(51) Int. Cl. H04L 12/24

(52) U.S. Cl. CPC H04L 41/04
USPC 709/246

(57) ABSTRACT

An apparatus and method for interconnecting heterogeneous networks is provided. The apparatus may include a controller to classify, for each level, control interfaces associated with an established virtual network, and a processor to convert each of the classified control interfaces into a common semantic model, wherein the processor may extract a convertible range from a language associated with a corresponding control interface to be converted, and may convert the corresponding control interface into a common semantic model, by changing a version of the extracted convertible range based on conversion rules.

### CROSS-REFERENCE TO RELATED APPLICATION

This application claims the benefit of Korean Patent Application No. 10-2012-0019262, filed on Feb. 24, 2012, in the Korean Intellectual Property Office, the disclosure of which is incorporated herein by reference.

### BACKGROUND

1. Field of the Invention

The present invention relates to a technology for supporting interconnection between heterogeneous networks, using a common model.

2. Description of the Related Art

Currently, although the Internet provides an excellent connectivity, various limitations in terms of performance, security, and the like are present due to an increasing amount of usage. In order to overcome such limitations, there is a desire for a network virtualization based programmable experimental infrastructure to be used for manufacturing a new type of the Internet structure and application.

Current systems established by multiple organizations or countries as a future Internet experimental environment, have been manufactured to be suitable for their own control apparatuses. Accordingly, the systems may differ from other experimental infrastructures in terms of control interfaces.

However, for research on a more practical future Internet, a network for the current Internet or large-scale networks of a similar level may need to be configured. The configuration of the network may be achieved by interconnecting future Internet experimental networks established independently.

Accordingly, there is a need for a technology for interconnecting heterogeneous network infrastructures that are essential to establish a large-scale future Internet infrastructure.

### SUMMARY

An aspect of the present invention provides an apparatus and method that may readily support interconnection between heterogeneous networks, using a common model.

According to an aspect of the present invention, there is provided an apparatus for interconnecting heterogeneous networks, the apparatus including a controller to classify, for each level, control interfaces associated with an established virtual network, and a processor to convert each of the classified control interfaces into a common semantic model. Here, the processor may extract a convertible range from a language associated with a corresponding control interface to be converted, and may convert the corresponding control interface into a common semantic model, by changing a version of the extracted convertible range based on conversion rules.

According to another aspect of the present invention, there is provided a method of interconnecting heterogeneous networks, the method including classifying, for each level, control interfaces associated with an established virtual network, and converting each of the classified control interfaces into a common semantic model. Here, the converting may include extracting a convertible range from a language associated with a corresponding control interface to be converted, and converting the corresponding control interface into a common semantic model, by changing a version of the extracted convertible range based on conversion rules.

According to example embodiment of the present invention, it is possible to readily support interconnection between heterogeneous networks, using a common model.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for interconnecting heterogeneous networks according to an embodiment of the present invention;

FIG. 2 is a block diagram illustrating a configuration of an apparatus for interconnecting heterogeneous networks according to an embodiment of the present invention;

FIG. 3 is a diagram illustrating an example of configuring virtual networks in an apparatus for interconnecting heterogeneous networks according to an embodiment of the present invention;

FIG. 4 is a diagram illustrating devices included in a platform to configure a virtual network in an apparatus for interconnecting heterogeneous networks, and a performing procedure according to an embodiment of the present invention; and

FIG. 5 is a flowchart illustrating a method of interconnecting heterogeneous networks according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

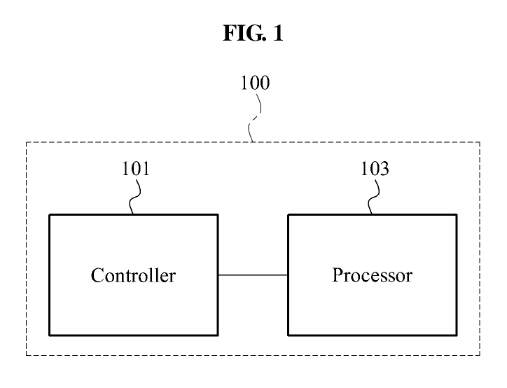

FIG. 1 is a block diagram illustrating an apparatus 100 for interconnecting heterogeneous networks according to an embodiment of the present invention. Hereinafter, the apparatus 100 for interconnecting the heterogeneous networks will be referred to as the interconnecting apparatus.

Referring to FIG. 1, the interconnecting apparatus 100 may include a controller 101, and a processor 103.

The controller 101 may classify, for each level, control interfaces associated with an established virtual network.

The processor 103 may convert each of the classified control interfaces into a common semantic model. In particular, the processor 103 may extract a convertible range from a language associated with a corresponding control interface to be converted, and may convert the corresponding control interface into a common semantic model, by changing a version of the extracted convertible range based on conversion rules. Here, the conversion rules may include a mathematical expression method, and a logical expression method.

In this instance, the processor 103 may perform the conversion with respect to a language that is provable using the mathematical expression method or the logical expression method, within the extracted convertible range. For example, when an extensible markup Language (XML)-X is extracted as the convertible range and the XML-X is expressed using one of Pi-Calculus, Object-Z, and Higher-Order Logic (HOL), the processor 103 may determine the XML-X to be the language that is provable using the mathematical expression method or the logical expression method.

The processor 103 may convert each of the control interfaces into the common semantic model with respect to a first virtual network and a second virtual network that are distinct from each other, and may interconnect the first virtual network and the second virtual network, using each of the converted control interfaces. In this instance, the processor 103 may interconnect the first virtual network and the second virtual network, by performing a horizontal combination including a node and a link in each of the first virtual network and the second virtual network, performing a vertical combination such that the first virtual network and the second virtual network have a hierarchical relationship, or performing a partial combination (̂) constituting the horizontal combination (+) or the vertical combination (*) using a portion of the first virtual network or a portion of the second virtual network.

Here, when a network X and a network Y are expressed using a graph, the horizontal combination may refer to a concept of combining a node and a link of the network X with a node and a link of the network Y. In this instance, a connection point of the network X and the network Y may be assigned randomly or specified directly.

The vertical combination may correspond to a network logically having a hierarchical relationship. X*Y denotes to a combination indicating that a message exchange in the network X is to be performed through the network Y, internally. In other words, the existing network Y may configure a one level upper network X.

The partial combination may express Y corresponding to a portion of the network X. The horizontal combination or the vertical combination may be performable using the portion of the network X.

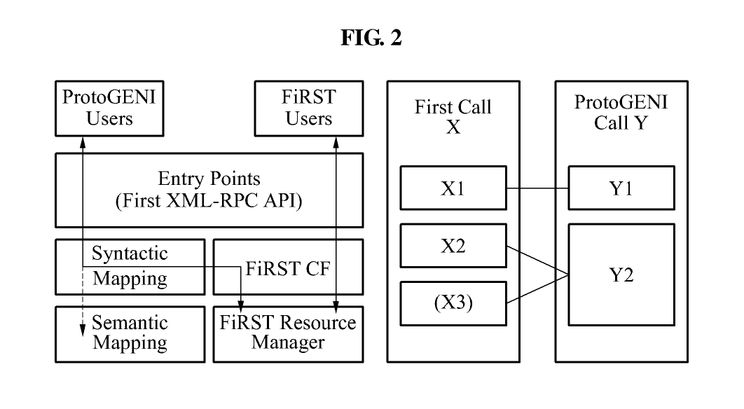

FIG. 2 is a block diagram illustrating a configuration of an apparatus for interconnecting heterogeneous networks according to an embodiment of the present invention.

Referring to FIG. 2, the interconnecting apparatus may support resource sharing, connecting a virtual network between resources, and application services based on resource sharing, connecting a virtual network between resources, and application services. The interconnecting apparatus may be configured using a minimum concept model that is used to process the entire process of reserving resources inquired by a user, generating a virtual network by configuring a topology, and setting and operating an application service.

Here, the resources may refer to computing resources configured using an operation apparatus, a storage apparatus, and an input and output apparatus, and may include network equipment, such as a personal computer (PC), a general-purpose server, a switch, and a router, a storage server providing a storage function, a personal terminal, such as a smart phone, and the like. On a basic model, the resources may be expressed by a processing rate, an available memory, and a storage space of an operating apparatus, the number and types of input and output interfaces, for example one local area network (LAN) input, two outputs, one Bluetooth, and one wireless-fidelity (Wi-Fi), and the like. The use of the resources dedicated to a switch may be fundamentally limited by a control apparatus providing the corresponding resources, or may be defined specifically in an upper application stage. The definition may include, for example, providing a router function by receiving assigned, expressed resources using a general-purpose computing apparatus.

Here, the application, for example, a service, may include system software of an operating system (OS) or kernel module level, and application software that may operate on a predetermined OS or a platform. For example, when a resource A is configured using 1 gigahertz (GHz) 64 bit×86, a 1 gigabyte (GB) memory, a 10 GB storage apparatus, a 1 NETFPGA card, and 1 Wi-Fi, the application may be composed of a cache server according to CentOS 5.5. When a resource B is based on a Java Virtual Machine (JVM) that provides 1000 million instructions per second (mips), a 1 GB memory, and a 100 megabyte (MB) external storage apparatus, the application may configure an application B in which Java Byte Code is set using a target language. When a resource C corresponds to a Tomcat-based web platform according to a performance specification similar to the resource A or the resource B, the application may be configured through a web application similar to a WiKi implemented by a sublet. When a resource D corresponds to an Android-based smart phone, the application may be configured using Android apps. When a resource E corresponds to an OpenFlow switch, the application may correspond to NOX or Beacon, OpenFlow protocol commands, and a FlowTable entry.

In order to realize a network configuration and operation of an application service, the interconnecting apparatus may support, in particular, a method of expressing resources, a method of sharing resources, a function of connecting resources, and a mechanism of setting and operating application services. Here, the method of sharing resources may include a method of utilizing resources in a heterogeneous control apparatus, a procedure and method of requesting, reserving, and returning predetermined resources using a resource expression, a method of providing and collecting resources belonging to each control apparatus and controlling an amount of resources to be used and authority according to a policy of each control apparatus, and a method of providing minimum interface information to be used to utilize resources. The function of connecting resources may include providing an interface or function for processing a request for a connection between at least two resources included in a predetermined control apparatus and supporting a connection to a heterogeneous control apparatus as necessary, and a software defined networking (SDN) interface such as tunneling, a Virtual local area network (VLAN), and OpenFlow. In addition, the mechanism of setting operating application services may include installing and setting applications, controlling executions, and installing an application A in each of resources 1, 2, and 3.

The interconnecting apparatus may be configured using a predetermined model, a language to express the model, and a format of a point of view of relative conversion, as opposed to a profile format. For example, the interconnecting apparatus may express a resource “a” of a platform X to be XML of a schema X type, and may express a resource “b” of a platform Y to be RDF. However, the interconnecting apparatus may not allow both predetermined XML and predetermined RDF, and may restrict an expression of the XML from a point of view of X within a range allowed in Y, and restrict an expression of the RDF from a point of view of Y within a range allowed in X, thereby interconnecting the heterogeneous networks.

Here, a common model may refer to a set of relative semantic spaces with respect to semantic models that are used in X and Y. Although a single predetermined common model is defined, and all platforms that may be interconnected are compliant with the defined common model, the common model may be changed at any time, and a changed common semantic model may need to describe conversion rules and methods with respect to an existing model.

That is, the common model may be the basis of conversion between heterogeneous control interfaces. The interfaces that may be interconnected with each other may need to be converted into common models although syntactic expressions differ from each other. For example, when a system A configures a virtual network by reserving resources through GENI AM API and RSpec, and a system B configures a virtual network by reserving resources through FiRST AM API and RSpec, the interconnecting apparatus may convert a request expressed through GENI AM API and RSpec into a common semantic model, and may convert a request expressed through FiRST AM API and RSpec into a common semantic model, thereby interconnecting the system A and the system B.

A common semantic model based convertible language and format may need to be proved in a mathematical or logical manner. For example, an XML format, called XML-X, used in a system X may be expressed semantically using a mathematical or logical model. The XML-X may need to be expressed using Pi-Calculus, Object-Z, or HOL, and may provide automatic conversion tools or specify manual conversion procedures.

Here, the conversion rules may include a procedure of converting and comparing semantic ranges, restriction attributes, a mathematical expression method, and a logical expression method.

For example, an example of a common semantic model based change may be expressed as shown in Table 1.

TABLE 1
[Common Semantic Model] [symbol]
1. View available resources with restriction I, J, K [symbol]
2. Create a Virtual Network VN1 using Resource A from X and

Resource B from Y connected through OpenFlow with OpenFlow
configuration C

[symbol]

3. Configure Service P with submodule Q and R over VN1 [symbol]
[GENI] [symbol]
1. ListResources −> GENI RSpec [symbol]
2. CreatSlice(CreateSilvers) using Resource A(VM) and Resource

B(VSwitch) from Emulab (represented in GENI RSpec) and Resource
C(virtual router) from FIRST (represented in GENI RSpec,
transformable into FIRST RSpec [symbol]
A. IssueTickets for A, B, C [symbol]
B. RedeemTickets for A, B, C [symbol]
C. Check return of CreateSilvers

[symbol]

3. Configure Service P with installing X.tar.gz on Resource A and B

and C using GENI RSpec

[symbol]

[symbol]

[PANTO] [symbol]
1. Browse Available Resources −> XML/JSON [symbol]
2. Compose a slice specification −> PANTO Specification Language [symbol]
3. Create a Slice with slice_specification.pt and Run

[symbol]

A. RegisterSliceName(x) [symbol]
B. ReserveResources(a, b, c, d, e) [symbol]
C. LinkingResources(link_spec) [symbol]
D. SetupService(service_spec)

[symbol]

As shown in Table 1, although expressions and steps differ from each other, the interconnecting apparatus may convert control interfaces into common semantic models that are expressed greatly using a first step, a second step, and a third step. [GENI] and [PANTO] do not seem to have a direct association, however, may be compatible with each other through conversion into a common semantic model.

Here, there is one-to-one correspondence between the steps of GENI and the steps of PANTO. In reality, however, 1, 2, 3, and 4 of X may need to be map to 1, and 2 of Y. Here, (m:n) conversion rules may also specify such mapping.

Control interfaces may be classified for each level. A first control interface may be at a highest level, may correspond to an interface that includes expressions, from an application service expression to a connection state expression. A second control interface may be at a lower level than the first control interface, and may include a resource inquiry expression, a resource reservation expression, a resource assignment expression, and a resource connection expression. In addition, a third control interface may be at a lowest level, and may express only a resource expression, or a connection state of a virtual network between resources. The third control interface may be used as a part of au uppermost interface or an intermediate interface.

The first control interface, the second control interface, and the third control interface may sequentially have an inclusion relationship, and may be combined with each other when sequences between levels match each other. For example, in order to include operating services, resources, and configuring a virtual network using a language X of an uppermost level, the interconnecting apparatus may use GENI API and RSpec to assign the resources, and may use an OpenFlow protocol and GENI RSpec or convert a corresponding portion to connect the virtual network.

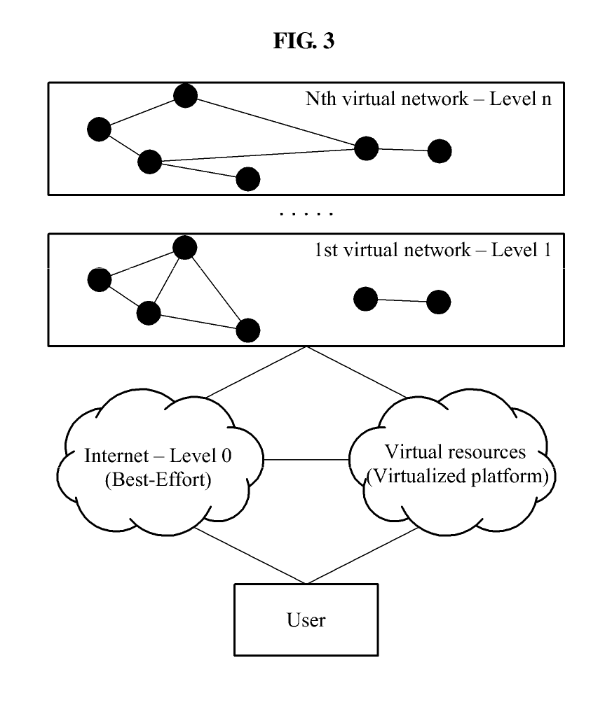

FIG. 3 is a diagram illustrating an example of configuring virtual networks in an apparatus for interconnecting heterogeneous networks according to an embodiment of the present invention.

Referring to FIG. 3, the interconnecting apparatus may configure, through a network virtualized platform, a predetermined virtual private network from the current Internet or a virtual network configured using various physical devices, and may configure another virtual network of a new level based on the configured virtual resources and the configured virtual private network.

A user may have an authority to use the existing Internet environment, and at least one predetermined virtualized platform. The user may establish a virtual network by utilizing resources provided by the entire virtualized platform or at least one platform, according to an interconnection policy of each platform. A general user and a virtual network provider may be distinguished based on types of an operation performed in a process of generating a network, a set authority, and the like.

A node of a virtual network may provide an interface that may be identified and accessed on a typical web. A general user may not need to intervene in a process of configuring a specific virtual network. Only a user or a desired site may configure a virtual network through a unique identifier. The virtual network provider may generate, maintain, or delete a virtual network using virtual resources and physical resources of a predetermined platform, in order to generate the virtual network desired by the general user.

Here, the virtual network may refer to physical resources and virtual resources provided by the existing Internet environment, directly. In addition, a predetermined node of a primary virtual network generated from the physical resources and the virtual resources, or from physical resources may act as an element that configures a virtual network of an upper level. However, new levels may not be generated infinitely. That is, the interconnecting apparatus may not infinitely repeat generating a node at an upper level in a form identical to a node of a lower level. In addition, the interconnecting apparatus may generate a fast path in an internal portion of a platform, with respect to various levels of virtual resources. However, the interconnecting apparatus may present adjusted levels that are formed when the fast path is generated, from a point of view of the general user, and a logical point of view.

The interconnecting apparatus may refer to a profile in which desired properties are recorded, when generating the virtual network. Here, the profile may include various attributes, for example, a network configuration participant, that is, a node, a security level, a guaranteed minimum bandwidth, a response rate, and the like.

Accordingly, the interconnecting apparatus may automatically look-up and assign currently available virtual resources and physical resources by accessing the predetermined virtualized platform, using the identifier and the profile with respect to the virtual node, generate a path for the virtual network, and return corresponding results to the general user, in the process of configuring the virtual network on a web.

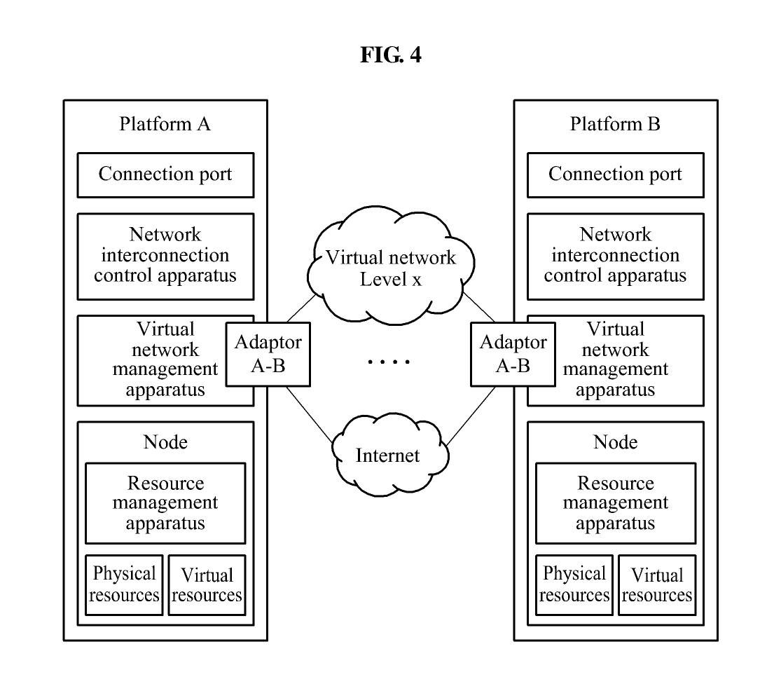

FIG. 4 is a diagram illustrating devices included in a platform to configure a virtual network in an apparatus for interconnecting heterogeneous networks, and a performing procedure according to an embodiment of the present invention.

Referring to FIG. 4, the interconnecting apparatus may configure the virtual network, using a portion of elements of a platform, for example, a resource management apparatus, a virtual network management apparatus, and a network interconnection control apparatus.

The platform may include the resource management apparatus to manage virtual resources and physical resources, the virtual network management apparatus to generate, maintain, and delete a virtual network desired by a user based on the virtual resources and the physical resources, and to reflect, in the virtual network, a result of analyzing a profile of the virtual network and an authority of the user, and the network interconnection control apparatus to interconnect platforms established by different organizations using different technologies to provide much more resources.

The resource management apparatus may assign and return actual resources provided by a physical server, and virtual resources provided through a virtual machine monitor, to a user and a virtual node, and may monitor a current availability. Here, the actual resources may include, for example, a central processing unit (CPU), a network card, a storage space, and the like.

The virtual network management apparatus may monitor the virtual network requested by the user, assign resources to an element of the virtual network requested by the user by looking-up the resources in a node including the physical server, monitor a state of the virtual network being used by the user, and return the node assigned to the virtual network by deleting the virtual network after use. When generating the virtual network, the virtual network management apparatus may configure specific resources based on the profile transferred from the user, and may set a communication scheme and performance restrictions between nodes constituting the virtual network. Technical details of connecting virtual nodes may accept various technologies of transmission and network layers, including generic routing encapsulation (GRE) tunnels and various virtual private network (VPN) technologies.

The virtual network management apparatus may simply generate the virtual network and assign resources, and also may completely separate a detailed subordinate technology for implementing a virtual network of an upper level from a concept of the virtual network of the upper level. The virtual network management apparatus may record a level of the virtual network at which physical resources and virtual resources are currently being used by a corresponding node. When a request for configuring a new network is received, the virtual network management apparatus may implement network configuration rules, for example, preventing concentration on resources that are already assigned and used, or of which a level is increased infinitely.

The network interconnection control apparatus may enable resources provided by the current platform and another platform to be used as elements of the virtual network requested by the user. In addition, the network interconnection control apparatus may provide interfaces that may investigate an availability of the resources of the current platform at an external platform, and may investigate a state and a list of another platform.

The interconnecting apparatus may maintain a distributed platform form, rather than including a separate central server. When interfaces with respect to the other platform are not supported, the interconnecting apparatus may dynamically request, from a corresponding platform, an interconnection interface module to be used for configuring a network and sharing resources, and may operate in a structure in which a transferred module may be operated without delay.

The interconnecting apparatus may utilize a technology for network virtualization to configure virtual networks in a form randomly desired by a user of the current Internet environment at various levels. When systems may be convertible based on a minimum common model although the systems that automatically generate the desired virtual network through a web interface, without complex procedures, are established independently from each other, the interconnecting apparatus may extend to a relatively great scale platform through the interconnection.

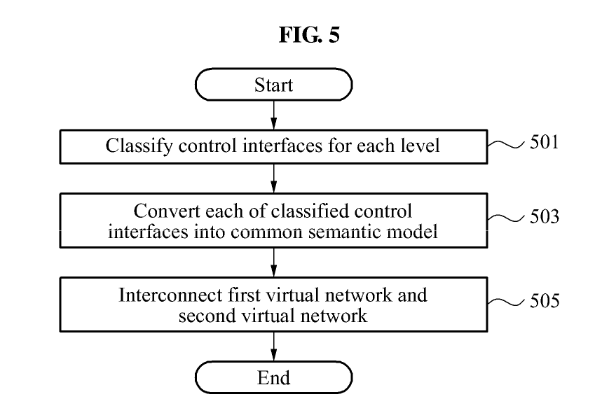

FIG. 5 is a flowchart illustrating a method of interconnecting heterogeneous networks according to an embodiment of the present invention. Here, the method of FIG. 5 may be performed by an apparatus for interconnecting heterogeneous networks according to an embodiment of the present invention.

Referring to FIG. 5, in operation 501, the interconnecting apparatus may classify, for each level, control interfaces associated with an established virtual network. In this instance, the interconnecting apparatus may classify control interfaces for each level, with respect to a plurality of virtual networks, for example, a first virtual network and a second virtual network that are distinct from each other.

In operation 503, the interconnecting apparatus may convert each of the classified control interfaces into a common semantic model.

In this instance, the interconnecting apparatus may extract a convertible range from a language associated with a corresponding control interface to be converted, and may convert the corresponding control interface into a common semantic model, by changing a version of the extracted convertible range based on conversion rules. Here, the conversion rules may include a mathematical expression method and a logical expression method.

In particular, the interconnecting apparatus may perform the conversion with respect to a language that is provable using the mathematical expression method or the logical expression method, within the extracted convertible range. For example, the interconnecting apparatus may determine an extensible markup Language (XML)-X to be the language that is provable using the mathematical expression method or the logical expression method, when the XML-X is extracted as the convertible range and the XML-X is expressed using one of Pi-Calculus, Object-Z, and HOL.

In operation 505, the interconnecting apparatus may interconnect the first virtual network and the second virtual network, using each of the converted control interfaces. In this instance, the interconnecting apparatus may interconnect the first virtual network and the second virtual network, by performing a horizontal combination including a node and a link in each of the first virtual network and the second virtual network, performing a vertical combination such that the first virtual network and the second virtual network have a hierarchical relationship, or performing a partial combination constituting the horizontal combination or the vertical combination using a portion of the first virtual network or a portion of the second virtual network.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for interconnecting heterogeneous networks, the apparatus comprising:
a controller to classify, for each level, control interfaces associated with an established virtual network; and
a processor to convert each of the classified control interfaces into a common semantic model,
wherein
the processor extracts a convertible range from a language associated with a corresponding control interface to be converted, and converts the corresponding control interface into a common semantic model, by changing a version of the extracted convertible range based on conversion rules.

2. The apparatus of claim 1, wherein
the conversion rules comprises a mathematical expression method, and a logical expression method, and
the processor performs the conversion with respect to a language that is provable using the mathematical expression method or the logical expression method, within the extracted convertible range.

3. The apparatus of claim 2, wherein the processor determines an extensible markup Language (XML)-X to be the language that is provable using the mathematical expression method or the logical expression method, when the XML-X is extracted as the convertible range and the XML-X is expressed using one of Pi-Calculus, Object-Z, and Higher-Order Logic (HOL).

4. The apparatus of claim 1, wherein the processor interconnects a first virtual network and a second virtual network that are distinct from each other, using each of the converted control interfaces.

5. The apparatus of claim 4, wherein the processor interconnects the first virtual network and the second virtual network, by performing a horizontal combination including a node and a link in each of the first virtual network and the second virtual network, performing a vertical combination such that the first virtual network and the second virtual network have a hierarchical relationship, or performing a partial combination constituting the horizontal combination or the vertical combination using a portion of the first virtual network or a portion of the second virtual network.

6. A method of interconnecting heterogeneous networks, the method comprising:
classifying, for each level, control interfaces associated with an established virtual network; and
converting each of the classified control interfaces into a common semantic model;
wherein
the converting comprises extracting a convertible range from a language associated with a corresponding control interface to be converted, and converting the corresponding control interface into a common semantic model, by changing a version of the extracted convertible range based on conversion rules.

7. The method of claim 6, wherein
the conversion rules comprises a mathematical expression method, and a logical expression method, and
the converting comprises performing the conversion with respect to a language that is provable using the mathematical expression method or the logical expression method, within the extracted convertible range.

8. The method of claim 7, wherein the converting comprises determining an extensible markup Language (XML)-X to be the language that is provable using the mathematical expression method or the logical expression method, when the XML-X is extracted as the convertible range and the XML-X is expressed using one of Pi-Calculus, Object-Z, and Higher-Order Logic (HOL).

9. The method of claim 6, further comprising:
interconnecting a first virtual network and a second virtual network that are distinct from each other, using each of the converted control interfaces.

10. The method of claim 9, wherein the interconnecting comprises:
performing a horizontal combination including a node and a link in each of the first virtual network and the second virtual network;
performing a vertical combination such that the first virtual network and the second virtual network have a hierarchical relationship; or
performing a partial combination constituting the horizontal combination or the vertical combination using a portion of the first virtual network or a portion of the second virtual network.
